(19) United States
(12) Patent Application Publication
(10) Pub. No.: US 2011/0198840 A1
(43) Pub. Date: Aug. 18, 2011

(54) Multi-coupling device for multiple quick-coupling connection of several hydraulic, electrical and pneumatic lines, equipped with decompression system

(75) Inventors: Roberto Sorbi, Rivolta D'Adda (IT); Enrico Debernardi, Rivolta D'Adda (IT); Daniele Rossetti, Dovera (IT)

(73) Assignee: Faster S.p.A.

(21) Appl. No.: 12/931,852

(22) Filed: Feb. 10, 2011

(30) Foreign Application Priority Data
Feb. 16, 2010 (EP) 10425038.6

(51) Int. Cl. F16L 37/08; F16L 39/00

(52) U.S. Cl. 285/81

(57) ABSTRACT

The present invention relates to a multi-coupling device (1) of the plate (2) type connectable to a vehicle or apparatus and supporting a plurality of semi-couplings (3), each connected to a hydraulic line and adapted to be connected to a corresponding semi-coupling of a second multi-coupling plate for connecting said hydraulic lines with a utility. The device according to the present invention is characterized in that it also comprises means (4) for connecting and disconnecting said first plate (2) to/from said second plate, characterized in that it further comprises a hydraulic system for decompressing said hydraulic lines.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

### Description

The present invention relates to a multi-coupling device of the plate type for connecting a plurality of hydraulic, electrical and pneumatic lines by means of quick couplings.

In various industrial fields, the need to simultaneously connect a plurality of lines, whether hydraulic, electrical and/or pneumatic lines, has now been consolidated for a long time. This need is felt in the agricultural field, for example, for connecting buckets, lifters, forklifts and any agricultural equipment to be connected to a tractor, for example; in the construction field, in asphalting or cement machines, in hydraulic hammers and the like; in the transport field for connecting a snow plough, trailers and the like, and so forth.

Therefore, the need to be able to connect several hydraulic, electrical and pneumatic lines is particularly felt, thus saving time, avoiding fluid leakages or air inclusions in the lines during the connection and disconnection steps, and avoiding dangerous connection errors such as, for example, the reversal of two lines.

Some technical solutions meet these requirements, the most well-known and functional solution consisting of a multi-connection plate known on the market with the trade name Multifaster and for some aspects already the subject matter of the Italian Patent IT1271165 and for other aspects of European Patents EP 0 787.905 B1 and EP0 522 493 B2 assigned to the same Applicant, which comprises two connection plates, one of which is connected to an auxiliary device to be connected and therefore it is movable, while the other is generally connected to the vehicle or apparatus to which said auxiliary device is to be connected, and therefore it is fixed.

Another example of a multi-connection device known from the prior art is disclosed by the prior application WO 2007/101516 A1, which discloses a device comprising two plates and a plurality of first and second fluid connections, and means to connect and disconnect the first and the second plates.

Therefore, each of the two plates accommodates a plurality of quick couplings. In particular, the fixed plate is preferably equipped with flat-face, female couplings, while the movable plate is equipped with corresponding flat-face, male couplings. From 1 to 12 hydraulic, electrical and pneumatic lines simultaneously

Therefore, each of the two plates accommodates a plurality of quick couplings. In particular, the fixed plate is preferably equipped with flat-face, female couplings, while the movable plate is equipped with corresponding flat-face, male couplings. From 1 to 12 hydraulic, electrical and pneumatic lines simultaneously exist on these plates. Each utility generally has one outflow line and one inflow line, whereby for each utility two pairs of couplings are required.

The fixed plate in particular, i.e. the one connected to the source vehicle or machinery releasing energy and/or pressurized fluids, has been the object of specific design attention as its surface has been made so as to be completely flat to allow easy and fast cleaning thereof.

The connection plate of the auxiliary device, the movable one, generally has construction elements such as for example connector pins, fittings to connect hydraulic piping and electrical connectors, positioned so as to protrude from the lower surface of the movable connection plate, while the fixed connection plate assembled on the vehicle or apparatus, as previously mentioned, is provided with holes and seats to introduce said pins and fittings, as well as with electrical connectors accommodated within the body of the fixed plate, which thus has a flat and smooth surface. Thereby, the surface of the flat plate may be easily cleaned when the movable plate of the auxiliary device is connected, the flat plate being also conveniently resealable by means of a protective cover which prevents the plate and the female couplings from getting soiled during the period of non-use.

With regards to connecting and disconnecting the movable plate to/from the fixed plate, this occurs due to a locking handle or lever, easily seizable by the operator, swayable about a fulcrum integral with the main body to which the fixed plate is connected. Said lever is generally handle-shaped and is hinged to two sides of the fixed plate, each of the two sections of the handle hinged with said plate has a guide or eccentric groove capable of accommodating suitable pins provided on the movable plate, so that the action of said eccentric groove or cam on the pins moves the movable plate close to the fixed plate thus facilitating the correct insertion of the couplings and keeping the two plates firmly connected over the entire period of operation, during which time said lever is locked in the lowered position.

As a mechanical safety device, some of the types of multi-coupling plates described heretofore and known from the state of the art have a release button at one of the two hinging points of the handle to the plate, which should be pressed by the operator to release the lever, so as to move it from the operating position in which the lever keeps the plates in a position of mutual coupling, to the release position in which to proceed with uncoupling the two plates. Similarly, in the step of coupling the two plates, the handle is brought to the closing position and the device with the mechanical safety button snaps to its working position in which its locks the handle itself.

As long as the operator does not press the release button, mechanical stop elements, such as for example pawls or bushings, prevent the shifting of the lever and therefore the opening of the multiple connection, i.e. the separation of the two plates.

The plates of this type, available today on the market, cover a vast combination in terms of coupling dimensions and number of lines. Due to this solution, several hydraulic lines may be connected in a single manoeuvre without the risk of reversing them.

However, some drawbacks afflict these multiple plate couplings of known type.

Among these drawbacks, the main one relates to the possibility of connecting and disconnecting the plates when the lines are pressurized, i.e. when there is a pressurized fluid, typically oil but not only, in the hydraulic and/or pneumatic lines. Such a situation is disadvantageous in every circumstance, but especially in the case of a high number of lines and sizes of the couplings exceeding ½″.

Therefore, a further drawback left unsolved by the multiple plate coupling systems of the known type consists in that the connection-disconnection load is not independent from the pressure still present in the circuits of the fixed plate and/or movable plate, and independent from the number of lines with residual pressure. Currently, the operation of connecting/disconnecting the two plates may even be impossible when there are high pressures in the circuits. These pressures may remain both in the circuits of the utility and in those of the fixed part.

Moreover, a further drawback left unsolved by the multiple plate coupling systems of the type known from the state of the art is the riskiness of the disconnection operation under pressure. Since the devices of the known type do not have further safety devices other than the above-discussed mechanical safety catch for locking the lever, the operator can proceed to release the lever also when there are high pressures in the lines, which means that due to the pressures, as soon as the couplings are disconnected, the two plates may be suddenly separated at high speed, which entails just as sudden and quick raising of the lever, which may knock and injure the operator himself/herself.

Not least drawback, which afflicts the plates of the known type and related to the possibility of proceeding with the disconnection while having a pressurized fluid in the lines, consists in dispersing the working fluid (generally oil, but not only) in the surrounding environment.

Therefore, it is the primary task of the present invention to suppress or reduce the above-mentioned drawbacks.

Therefore, within the scope of this task, it is the object of the present invention to provide a multi-coupling plate connection system having an improved level of safety in all steps of use and in particular during connection and disconnection operations.

Moreover, it is a further object of the present invention to provide a multi-coupling plate connection system capable of allowing the coupling and uncoupling of the plates in complete safety even when there is a pressurized fluid in the hydraulic and/or pneumatic circuits, in particular also when there is a pressurized fluid both in the circuits of the fixed part and in the circuits of the movable part of the system.

It is a further object of the present invention to provide a multi-coupling plate system equipped with a safety system suitable for discharging the pressures and recovering decompressed and clean oil during the steps of coupling/uncoupling.

This task and these and other objects which will become more apparent below, are achieved by a multi-coupling device comprising a main body connectable to a vehicle or apparatus and supporting a first plate comprising a plurality of semi-couplings, each connected to a hydraulic line and suitable for being connected to corresponding semi-couplings of a second multi-coupling plate for connecting said hydraulic lines to the utility, said device further comprising means to connect and disconnect said first plate to/from said second plate, characterized in that it further comprises a hydraulic system for decompressing said hydraulic lines.

The device according to the present invention is also characterized in that said hydraulic system comprises in turn a hydraulic safety device for locking said lever.

### BRIEF DESCRIPTION OF THE DRAWINGS

Further features and advantages of the present invention will become more apparent from the following detailed description, provided by way of non-limiting example and illustrated in the accompanying drawings, in which:

FIG. 1 shows a side view of the multi-coupling device according to the present invention;

FIG. 2 shows a front view of the multi-coupling device according to the present invention according to the section with plane C-C denoted in FIG. 1;

FIGS. 2A, 2B and 2C show enlarged details of peculiarities in FIG. 2;

FIG. 3 shows a top view of the multi-coupling device according to the present invention according to the section with plane B-B denoted in FIG. 1;

FIG. 4 shows a hydraulic-circuit diagram of the multi-coupling device according to the present invention schematized in a top view;

FIG. 5 shows a schematic drawing of a non-return valve forming part of the hydraulic circuit in FIG. 4;

FIG. 6 shows a schematic drawing of the integrated mechanical safety catch system according to the present invention;

FIG. 7 shows a schematic drawing of a peculiarity of the hydraulic safety catch device of the multi-coupling device according to the present invention.

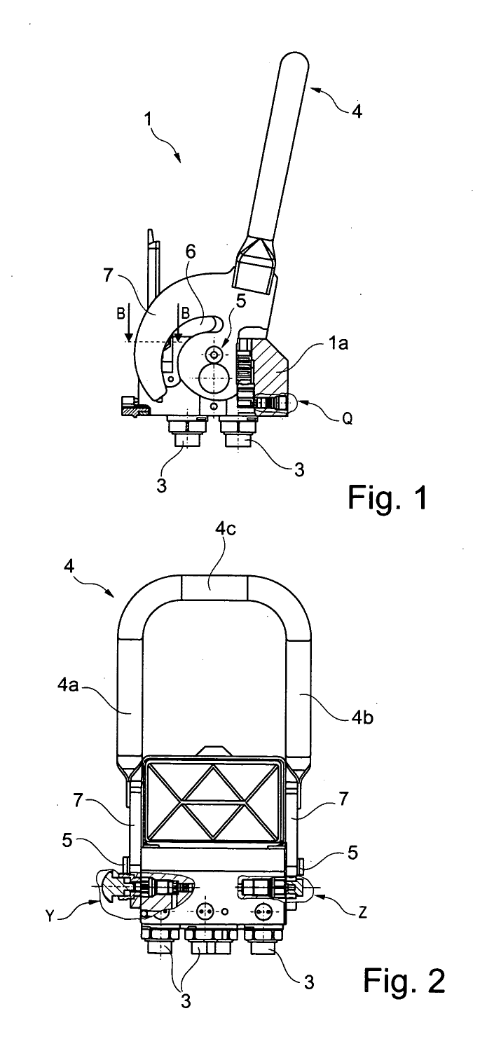

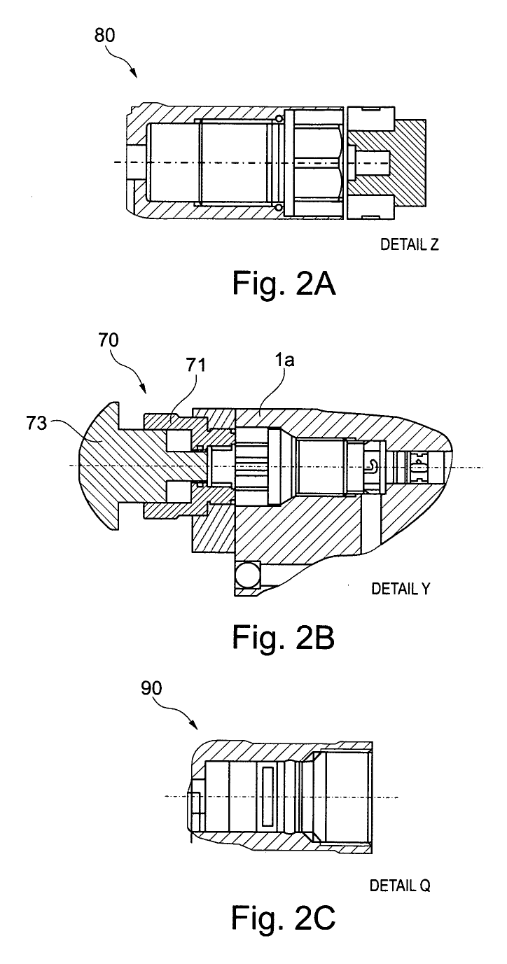

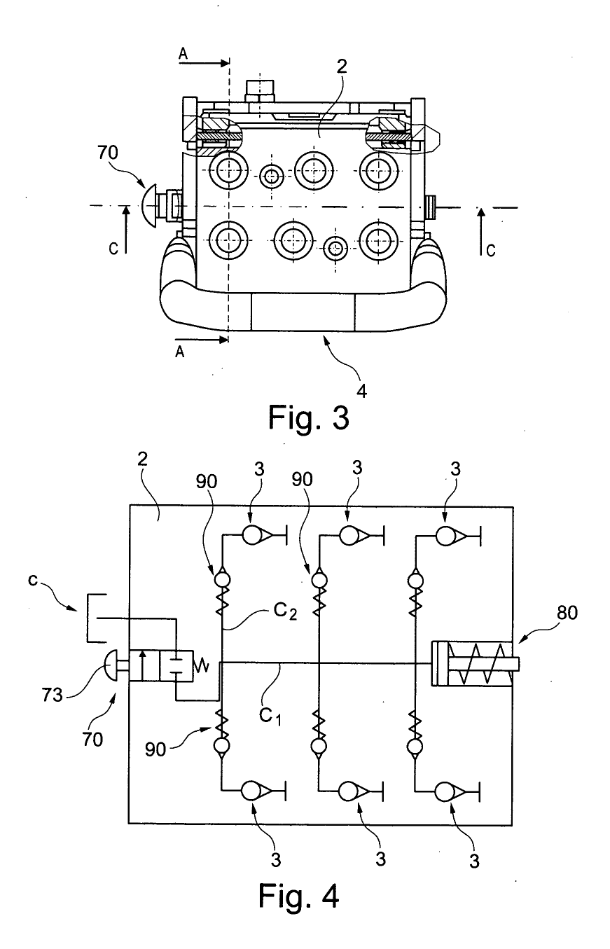

### DETAILED DESCRIPTION

According to a preferred embodiment of the present invention illustrated in the mentioned figures by way of a non-limiting example, the multi-coupling device 1 according to the present invention comprises a main body 1a supporting a plate element 2 in turn supporting a plurality of semi-couplings 3, preferably female semi-couplings. According to the teaching from the state of the art, a second plate (not shown in the figures) also supporting a plurality of semi-couplings (in this case of male type) may be coupled to the first plate 2, so that the semi-couplings supported by the two plates may embody the connection of just as many hydraulic lines.

The main body 1a of said device is fixedly connectable to a vehicle or apparatus, and the second movable plate is connected to a utility to be connected to such a vehicle or apparatus. The multi-coupling device 1 also advantageously comprises one handle 4, which is U-shaped in the example illustrated in the accompanying drawings, hinged to both of the sides of said main body 1a. In greater detail, said handle 4 has two substantially straight, levered sections 4a and 4b each hinged in a fulcrum 5 at two opposite sides of said plate 2, and they are joined to each other by a joining section 4c, particularly suitable for being seized by the user. Said sections 4a and 4b of said handle 4 are hinged to said main body 1a and each has a plate-like extension 7 on which an eccentric groove 6 is obtained. During the coupling step of the fixed plate 2 to said second movable plate, each of said eccentric grooves 6 receives a pin (not shown in the accompanying drawings) provided on said second movable plate, and has a shape such that once the pins of the second plate are positioned within the eccentric grooves 6 of lever 4 when the operator lowers the lever, reciprocal nearing is obtained and the two plates are closed one against the other, and therefore the male semi-couplings are coupled within the corresponding female semi-couplings.

When the locking handle 4 is lowered to the horizontal position by the operator, the plates supporting the semi-couplings interpenetrate thus embodying the connection of the hydraulic lines connected thereto. When the plates are correctly connected, the operator can bring the locking lever 4 to a substantially horizontal position in which mechanical safety catch means snap, thus firmly keeping the lever itself in the plate locking and closing position.

In the embodiment illustrated in the accompanying drawings and in particular in FIG. 6, said mechanical safety catch means comprise a mechanical safety catch pawl 71 integral with the plate-like portion 7a of the lever section 4a of said handle 4 being substantially hollow, cylindrical in shape and within which the safety button 73 is able to axially slide and rotate about its symmetry axis. Said safety button 73 is suitable to be operated by the user, whereby it externally protrudes from the side of the main body 1a. Again in greater detail, the mechanical safety catch means according to the embodiment shown in the accompanying drawings, provide that said safety button 73 is able to axially shift when pressed by the user, thus exerting in turn a bias on the mechanical stop and decompression shaft 72, which is also axially shiftable with respect to the body of the multi-coupling device, and which therefore, with reference to FIG. 6, shifts to the right with respect to the pawl 71. Hence, the stop shaft 72 may retract within the main body 1a thus pressing the helical return spring 75 and releasing handle 4. Indeed, in the stop position, the shaft 72 interferes with the walls of the internal cavity of said pawl 71 so as to prevent the lever and thus the plates from involuntarily opening, serving its function of mechanical safety catch.

The pressing action of the safety button 73 by the user thus releases the mechanical stop shaft 72, which forms part of the mechanical safety catch means.

The multi-coupling plate according to the present invention further comprises hydraulic safety catch means.

In particular, again with reference to FIG. 6, when the user presses the safety button 73, it is free to run an axial travel limited by a guide pin 74, provided integrally with said pawl 71 and suitable to slide within a specific groove (not shown in the figures) obtained on the external surface of the body of said safety button 73. When the button is pressed by the operator, the mechanical safety catch stop 72 is pushed and forced to return within the body of the multi-coupling plate, so that the plate is released. However, another pin is conveniently provided on the opposite side of the plate, suitable to interfere with lever 4, in particular with the plate-like extension 7b of the lever section 4b of handle 4. Said pin forms part of said hydraulic safety catch means.

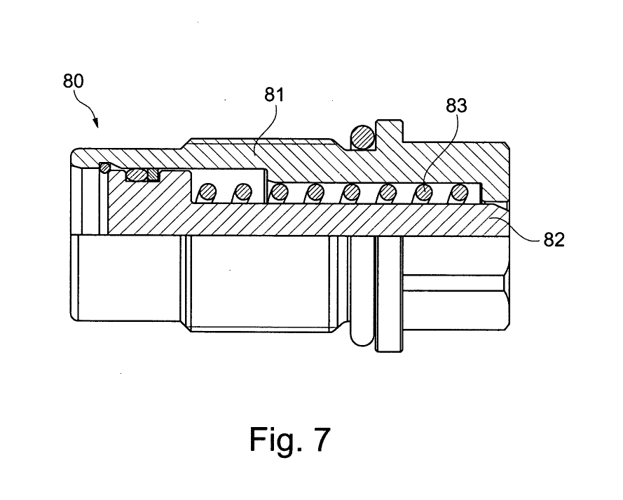

According to the schematization in FIG. 7, said hydraulic safety catch means 80 comprise a safety catch body 81 integral with the body of said plate which accommodates a pin 82 therein. Said pin 82 is slidingly associated with said safety catch body 81, and as shown in FIG. 7, is kept within the safety catch body 81 by the bias of the releasing spring 83.

Said mechanical and hydraulic safety catch means are both connected to a hydraulic circuit, schematically illustrated in FIG. 4 and generally indicated by letter A. Said hydraulic circuit connects each semi-coupling (indicated by numeral 3) to a bleed line c, a non-return valve 90 being provided on every branch of the circuit connected to the couplings. The bleed line c is also connected to said mechanical safety catch means 70 and to said hydraulic safety catch means 80.

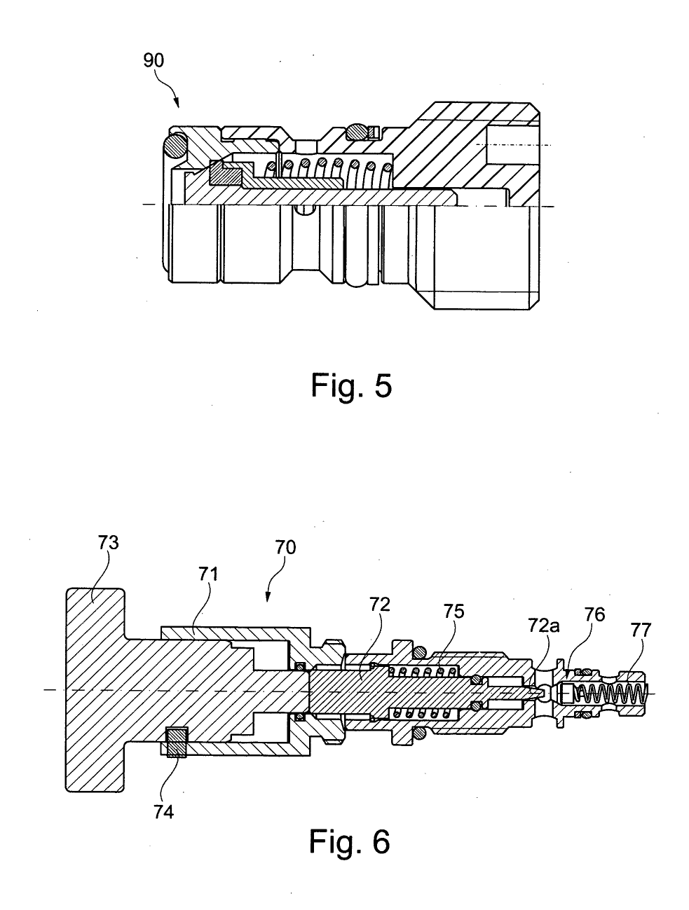

With specific reference to FIG. 4, the hydraulic circuit of the multi-coupling device according to the present invention allows the pressure to be discharged from the lines upon opening the hydraulic safety catch. The interrelated operation of the mechanical and hydraulic safety catch devices connected to the hydraulic circuit will be disclosed in greater detail below. Here, it is worth noting how the hydraulic circuit A provides for a bleed line c to collect the fluid (normally oil) from the couplings, therefore pressurized fluid is discharged from each hydraulic line, both of the energy source apparatus and the utility. In particular, by means of a branch c₂ on which said fluid shut-off valve 90 is provided, each semi-coupling 3 is connected to the main branch c₁ connecting said mechanical safety catch means 70 to said hydraulic safety catch means 80. An embodiment of a fluid shut-off valve is shown in FIG. 5, and generally indicated by reference numeral 90.

Returning to FIG. 6, as previously mentioned, the safety button 73 may shift and push the pin or mechanical safety catch stop 72 until it is partially released from handle 4, however only due to a subsequent rotation of said button 73 by the operator, it may further advance in the axial direction towards the bottom of the pawl 71, being guided by the fixed guide pin 74 on pawl 71 which interacts with a convenient spiral groove section obtained on the external surface of the button itself. This further shifting of button 73 involves analogous further shifting of the mechanical safety catch stop 72 to the right with the mechanical safety catch 72 being completely released from handle 4 in the example in FIG. 6, which prevails over the bias exerted by the return spring 75. At the opposite end with respect to the end adapted to strike against button 73, said mechanical safety catch stop 72 has a tapered conical section 72a adapted to strike a decompression valve 76, kept in the closing position by a helical spring 77.

The operation of the mechanical and hydraulic safety catch means 70, 80 as well as of the hydraulic circuit A of the multi-coupling device according to the present invention will now be described in greater detail.

With the plates being coupled, when the operator only applies pressure on button 73, it may shift without snapping the mechanical safety catch consisting of pin 72. Moreover, handle 4 may not yet be lifted as the hydraulic safety catch means 80 on the opposite side of the plate, in particular the pin 82 of the hydraulic safety catch, still prevents handle 4 from moving. If the operator rotates the button 73 once it has been pressed by the operator himself/herself, further shifting the mechanical safety catch stop 72 completes releasing the aforesaid mechanical safety catch and causes valve 76 to open, and the pressure in the hydraulic circuit A to be subsequently discharged. Indeed, valve 76 is placed to close the main branch c₁ of the hydraulic circuit A, where all branches c₂ connected to the couplings a converge. Hence, when the operator presses and rotates the button 73, the valve 76 opens to allow the bleeding, through line c, of the pressurized fluid in the lines (generally oil).

Therefore, the safety button 73 substantially comprises a mechanical stop and decompression shaft 72 which is movable between a first stopped position, corresponding to the condition of button 73 not pressed, in which said mechanical stop 72 prevents the opening movement of the connecting and disconnecting means 4, a second position that is also a mechanical stop, corresponding to the condition of pressed button, in which said mechanical stop 72 interferes with said connecting and disconnecting means 4, and a third decompression and mechanical non-interference position, corresponding to the condition of pressed and rotated button 73, in which said mechanical stop shaft 72 opens a valve 76 for decompressing the hydraulic circuit A.

As previously mentioned, the hydraulic safety catch means 80 are connected to the hydraulic circuit, as shown in the diagram in FIG. 4. In the detail in FIG. 7, the hydraulic safety catch 80 is connected on the left to the hydraulic circuit A, in particular to the main line c₁. When valve 76 is opened due to action on button 73, as there is a pressurized fluid, the pressure within the circuit A is bled from line c, from the hydraulic lines to the vehicle or apparatus, therefore the bias will be reduced which is exerted by the fluid in section c₁ on the pin 82 of the hydraulic safety catch until the bias induced on the pin 82 of the hydraulic safety catch is insufficient to counter the bias of spring 83 and the pin retracts within the main body of the device, biased by the spring, thus releasing the handle 4. By conveniently sizing the spring 83, the opening of pin 82 may be determined only when the pressure in circuit A drops below a predetermined threshold value.

Therefore, the multi-coupling device according to the present invention allows the operator to connect/disconnect the semi-couplings of the two plates even when there is pressurized fluid in the hydraulic lines. In particular, the multi-coupling device according to the present invention allows the couplings of the various lines to be connected/disconnected even when there is fluid at maximum operating pressure in the lines, and regardless of that the pressurized fluid is in the lines of the fixed part, in those of the movable part, or in both.

Indeed, it has been disclosed how the multi-connection device according to the present invention comprises a hydraulic circuit which integrates a decompression and recovery system for the fluid, comprising an outlet valve and a bleed line, and connected to hydraulic and mechanical safety catch means. The decompression system according to the above disclosure allows the pressure within the lines to be abated, and therefore the coupling and uncoupling loads of the couplings to be abated.

A further primary advantage achieved by the multi-coupling device according to the present invention consists in greater safety. Indeed, according to the above disclosure, lever 4 may be raised to open the multiple connection only once the pressure and the subsequent rotation of the safety button 73 by the user have abated the fluid pressure in the lines, due to the fluid decompression means. This solves the drawback which afflicts the systems of the type known from the state of the art, which may be uncoupled even when the lines are pressurized, and for which accidentally pressing the release button of the mechanical safety catch could have led to the violent uncoupling of the two plates due to the pressure in the lines, with the subsequent risk that the lever violently hits the operator and the fluid (generally oil) is dispersed into the surrounding environment.

Hence, a further advantage obtained by the multi-coupling device according to the present invention is that to succeed in recovering the decompressed clean oil during the coupling/uncoupling steps, which oil may be re-introduced into the hydraulic circuit of the machine or vehicle to which the multi-coupling device according to the present invention is connected.

Again, as previously mentioned, the multi-coupling device according to the present invention is equipped with a hydraulic circuit comprising a non-return valve or check valve for every coupling, so that each hydraulic line may be connected to the bleed line without hydraulic short-circuiting problems occurring between the lines. This contrivance makes the decompression system highly simple and reliable.

Several modifications may be made by the person skilled in the art without departing from the scope of protection of the present invention.

Therefore, the scope of protection of the claims should not be limited by the disclosures or preferred embodiments shown in the description by way of example, but rather the claims should comprise all features of patentable novelty inferable from the present invention, including all features which would be treated as equivalent by the field technician.

What is claimed is:

1. A multi-coupling device comprising a main body connectable to a vehicle or apparatus and supporting a first plate comprising a plurality of semi-couplings, each connected to a hydraulic line and adapted to be connected to corresponding semi-couplings of a second multi-coupling plate which are in turn connected to hydraulic lines for connecting said hydraulic lines to one another, said device further comprising means to connect and disconnect said first plate to/from said second plate, further comprising means for decompressing said lines during the step of connecting and disconnecting said first plate to/from said second plate, and in that said means for decompressing the hydraulic lines comprise at least one hydraulic circuit, in turn comprising a bleed line, and connected to said semi-couplings of said first plate and to safety catch means adapted to selectively allow or prevent the opening and closing of the plate connection when there is pressurized fluid in the hydraulic lines.

2. A multi-coupling device according to claim 1, wherein said safety catch means comprise mechanical safety catch means which interact with said connecting and disconnecting means.

3. A multi-coupling device according to claim 2, wherein said safety means further comprise hydraulic safety catch means which interact with said connecting and disconnecting means.

4. A multi-coupling device according to claim 3, wherein said mechanical safety catch means and said hydraulic safety catch means are in turn connected to said hydraulic circuit (A) and reciprocally interacting.

5. A multi-coupling device according to claim 4, wherein said hydraulic safety catch means prevent the plates from disconnecting so long as the fluid in the lines and therefore in the hydraulic circuit exceeds a predetermined threshold value.

6. A multi-coupling device according to claim 2, wherein said mechanical safety catch means may be manually operated by the user.

7. A multi-coupling device according to claim 6, wherein said mechanical safety catch means comprise a safety button adapted to be first pressed and then rotated by the user.

8. A multi-coupling device according to claim 7, wherein said safety button comprises a mechanical stop and decompression shaft which is movable between a first stopped position, corresponding to the condition of button not pressed, in which said mechanical stop prevents the opening movement of the connecting and disconnecting means, a second position which is also a mechanical stop, corresponding to the condition of pressed button, in which said mechanical stop interferes with said connecting and disconnecting means, and a third decompression and mechanical release position, corresponding to the condition of pressed and rotated button, in which said mechanical stop shaft opens a valve for decompressing the hydraulic circuit.

9. A multi-coupling device according to claim 8, wherein said hydraulic safety catch means comprise a safety catch body, which is integral with the main body of said device, which accommodates a pin therein which is slidingly associated therewith and movable between a first stopped position in which said pin protrudes from said safety catch body and interferes with said connecting and disconnecting means, and a second release position in which said pin is accommodated within said safety catch body and does not interfere with said connecting and disconnecting means.

10. A multi-coupling device according to claim 9, wherein said pin is movable between the two stopped and released positions according to the value of the pressure within the hydraulic circuit.
